(19) United States
(12) Patent Application Publication
(10) Pub. No.: US 2017/0326966 A1
(43) Pub. Date: Nov. 16, 2017

(54) Heat Exchanger System

(71) Applicant: AGCO International GmbH, Hesston, KS (US)

(72) Inventors: Julien MARCANT, Beauvais (FR); Valentin Daniel Joel LECONTE, Cempuis (FR); Laurent MEYER, Beauvais (FR)

(21) Appl. No.: 15/531,995

(22) PCT Filed: Dec. 2, 2015
(86) PCT No.: PCT/EP2015/078408

§ 371 Date: May 31, 2017

(30) Foreign Application Priority Data
Dec. 3, 2014 (EP) 14290366.5

(51) Int. Cl. B60K 11/04; F01P 3/18; F01P 5/02; B60K 11/08; F28F 27/02; F28D 1/04; F01P 3/00; F28D 21/00

(52) U.S. Cl. CPC B60K 11/04; F28F 27/02; F01P 3/18; F01P 5/02; F28D 1/0435; B60K 11/085; B60Y 2200/221; F01P 2003/006; F01P 2037/00; F28D 2021/008; F28F 2280/10; F01P 2003/182

(57) ABSTRACT

A heat exchanger system for an agricultural vehicle. The heat exchanger system has at least two separate heat exchanger assemblies, where an adjustable baffle is used to vary the airflow between the heat exchanger assemblies, accordingly varying the cooling effect of the assemblies, based on system requirements. The adjustable baffle may be arranged to restrict or block at least a portion of a heat exchanger to reduce airflow through the exchanger, to provide a flow bypass of an exchanger, and/or to proportionally adjust the airflow through a pair of heat exchangers provided as part of a single heat exchanger assembly.

### BACKGROUND OF THE INVENTION

### Field of the Invention

The present invention relates to a heat exchanger system for a vehicle, in particular a heat exchanger system having more than one heat exchanger assembly.

### Description of Related Art

In general, a heat exchanger transfers a heat from a relatively high temperature fluid to a relatively low temperature fluid. Heat exchangers are commonly used in vehicles, as part of engine cooling systems, HVAC systems, etc., where atmospheric air is drawn through a radiator to provide a cooling of the working fluid of the heat exchanger.

In some vehicles, e.g. agricultural tractors, a heat exchanger system may comprise a number of different heat exchangers, e.g. a first heat exchanger as part of an engine cooling system, and a second heat exchanger as part of an auxiliary cooling circuit, e.g. for oil cooling, HVAC applications, etc. In a space-saving effort, such separate heat exchangers may be provided in series with a fan, such that the airflow drawn by the fan is conveyed through both heat exchangers in series. However, such a series arrangement of heat exchangers does not allow for modification of the cooling effect provided between the different heat exchangers, and does not account for disparities in the required cooling levels of the separate heat exchangers. Such variation between the cooling requirements of the heat exchangers can lead to inefficient operation of the separate systems, as the different heat exchangers may be exposed to excessive or inadequate cooling levels, based on the requirements of the entire heat exchanger assembly as a whole.

An example of a prior art heat exchanger system having an adjustable flow guiding device is provided in DE 102010000969 A1.

It is an object of the invention to provide a heat exchanger system having improved efficiency.

### SUMMARY OF THE INVENTION

Accordingly, there is provided a heat exchanger system for a vehicle, the assembly comprising:

a first heat exchanger assembly;

a second heat exchanger assembly located downstream of said first heat exchanger assembly; and

at least one baffle arranged between the first heat exchanger assembly and the second heat exchanger assembly,

wherein said at least one baffle is adjustable to provide for variation of airflow between said first heat exchanger assembly and said second heat exchanger assembly.

The baffle is arranged to adjust the airflow between the first and second heat exchangers, based on the requirements of the heat exchangers. Accordingly, the exchange of energy provided by the heat exchangers can be varied based on the requirements of a vehicle engine and/or the exchangers themselves. Such an adjustable system allows for more efficient operation of the vehicle, as the performance of the heat exchanger system can be more accurately adjusted to take into consideration vehicle systems requirements. An example of such an efficiency improvement can include greater engine and transmission efficiency, due to a decrease in the warming-up time for the vehicle engine.

At least one of said first and second heat exchanger assemblies is provided as a plurality of separate heat exchanger subsections, wherein said at least one baffle is adjustable to control airflow to or from said separate heat exchanger subsections.

The heat exchanger assemblies may comprise a number of separate subsections, which can be linked with different subsections of a greater engine cooling system, e.g. different cooling circuits linked with different subsystems of the vehicle. The different subsystems may comprise a transmission oil cooling circuit, an auxiliary oil cooling circuit, a fuel cooler, a condenser for a HVAC system, a front PTO cooler, etc. The at least one baffle may be used to prioritise flow through one of the heat exchanger subsections of an assembly over flow through the other subsections, for example based on increased cooling requirements for that particular heat exchanger subsection.

Preferably, said at least one baffle is provided as a hinged member. Additionally or alternatively, said at least one baffle is provided with a linear actuator, arranged to selectively advance and retract said at least one baffle. Additionally or alternatively, said at least one baffle may comprise a telescopic member.

By hinging and/or linearly adjusting the baffle, a flow path defined by the baffle between the heat exchangers can be easily adjusted in shape and/or flow volume.

Preferably, said first and second heat exchanger assembly comprises a liquid coolant radiator and an air radiator, e.g. for intake air. The liquid coolant may comprise water or a mixture of water and antifreeze, e.g. ethylene glycol or propylene glycol.

In one aspect, said at least one baffle is actuable between a first position and a second position, wherein

in said first position, said at least one baffle is arranged to direct an output airflow from said first heat exchanger assembly as an input airflow to said second heat exchanger assembly;

in said second position, said at least one baffle is arranged to direct at least a portion of the output airflow from said first heat exchanger assembly to bypass said second heat exchanger assembly.

By providing a selectable bypass route for the second heat exchanger, the pressure drop across the second heat exchanger is reduced. Such a reduction in the pressure drop can act to reduce the fan consumption of the second heat exchanger, and accordingly of the entire heat exchanger system.

In a further aspect, the heat exchanger system comprises an additional baffle arranged upstream of said first heat exchanger assembly, wherein said additional baffle is adjustable to provide for variation of airflow into said first heat exchanger assembly.

The use of an additional baffle upstream of the first heat exchanger assembly allows for the control of the input airflow to the greater heat exchanger system. Such an additional baffle may be hingedly mounted and/or provided with a linear actuator to adjust the baffle position.

Preferably, at least one of said first and second heat exchanger assemblies comprises a plurality of heat exchangers, wherein said at least one baffle is adjustable to vary the proportion of airflow through the respective heat exchangers of said plurality.

The baffle may be variable to control the proportion of airflow, e.g. by adjusting an angular position of a hinged baffle or flap, to provide for an increased proportion of airflow through a first heat exchanger relative to a second heat exchanger of an assembly.

Preferably, the heat exchanger system comprises at least one fan arranged in series with said first and second heat exchanger assemblies, said at least one fan arranged to cause air to be drawn through or blown into the heat exchanger assemblies of the heat exchanger system.

The fan may be provided upstream or downstream of the heat exchanger assemblies.

Preferably, said at least one baffle is arranged to selectively cover at least a portion of said second heat exchanger assembly, to prevent airflow through the portion of the second heat exchanger assembly.

There is also provided an agricultural vehicle, preferably an agricultural tractor, having a heat exchanger system as described above.

In a preferred embodiment, there is provided an agricultural vehicle comprising:

an engine;

an engine control unit (ECU) arranged to adjust engine performance based on sensor inputs; and

a heat exchanger system as described above coupled to said engine, wherein said ECU is operable to adjust the at least one baffle of said heat exchanger system based on sensor inputs received by said ECU.

### BRIEF DESCRIPTION OF THE DRAWINGS

Embodiments of the invention will now be described, by way of example only, with reference to the accompanying drawings, in which:

FIG. 1 is a view of an agricultural tractor;

FIG. 2 illustrates a heat exchanger system for a vehicle;

FIG. 3 illustrates a heat exchanger system for a vehicle according to a first embodiment of the invention;

FIGS. 4 and 5 illustrate a heat exchanger system for a vehicle according to a second embodiment of the invention; and

FIGS. 6 and 7 illustrate a heat exchanger system for a vehicle according to a third embodiment of the invention.

### DETAILED DESCRIPTION OF THE INVENTION

The drawings presented herein are not meant to be actual views of any particular heat exchanger system, but are merely idealised representations that are employed to describe embodiments of the present disclosure. The drawings presented herein are not necessarily drawn to scale. Additionally, elements common between drawings may retain the same numerals.

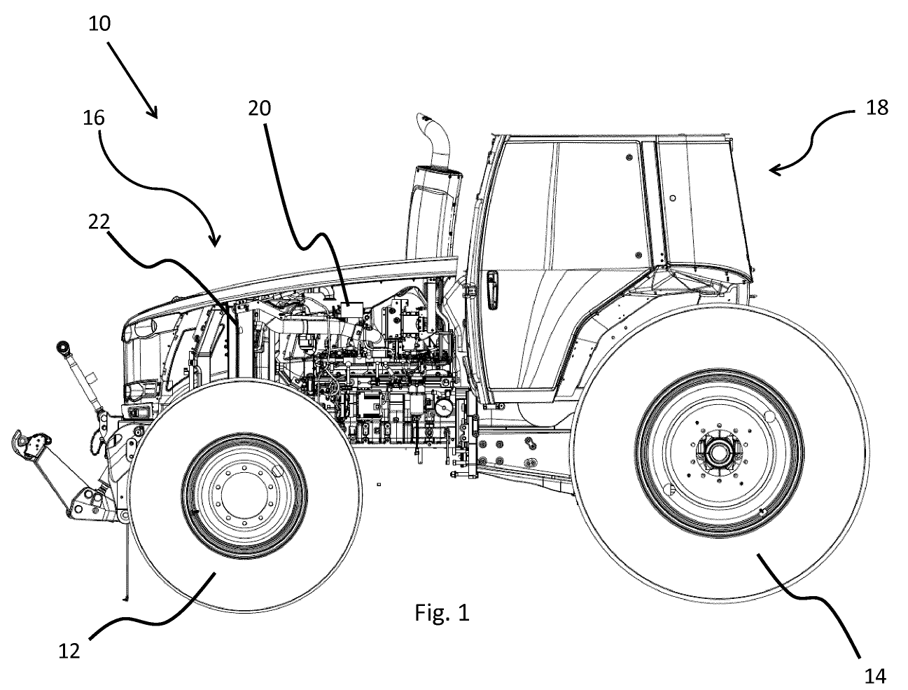

An agricultural tractor 10 is illustrated in FIG. 1. The tractor 10 comprises front wheels 12, rear wheels 14, an engine section 16 and a cab section 18. The engine section 16 comprises a tractor engine 20 and a cooling system 22 located adjacent to the engine 20.

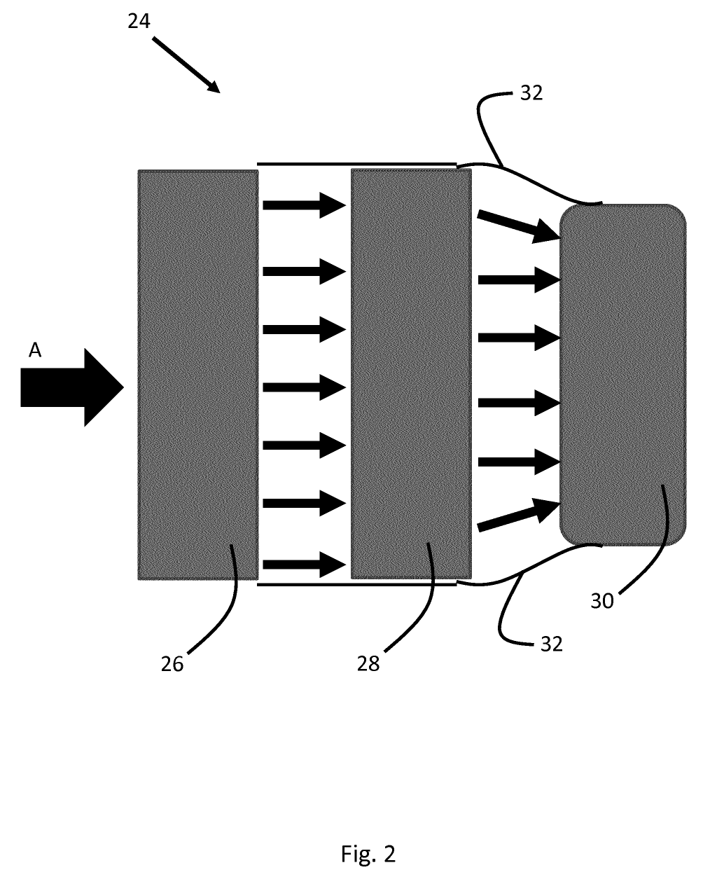

The cooling system 22 may comprise a heat exchanger system, as indicated at 24 in FIG. 2. The heat exchanger system 24 generally comprises a first heat exchanger assembly 26 and a second heat exchanger assembly 28, the second heat exchanger assembly 28 arranged downstream of the first heat exchanger assembly 26 along a flow path. The direction of the flow path is indicated by arrow A. The first and second heat exchanger assemblies 26,28 may be provided as part of separate heat exchanger subsystems (not shown) for use in the agricultural tractor. For example, the first heat exchanger assembly 26 may be provided as a cooler for transmission oil, while the second heat exchanger assembly 28 may be provided as a radiator for an engine cooling system. Other possible subsystems may include a hydraulic oil cooling system, a HVAC system, etc.

A fan 30 is arranged at the end of the flow path, downstream of the first and second heat exchanger assemblies 26,28. A fan shroud or duct assembly 32 is used to define the boundaries of the flow path between the heat exchanger assemblies 26,28 and the fan 30.

The first and second heat exchanger assemblies 26,28 generally comprise a radiator or other suitable device to receive a working fluid, e.g. water, engine coolant fluid, transmission oil, hydraulic oil, etc. The fan 30 is arranged to draw in air, indicated by arrows B, through the heat exchanger assemblies 26,28, to cool the contained working fluid.

As the cooling requirements of the first and second heat exchanger assemblies 26,28 may very independently of each other, it is desirable to be able to separately control the cooling effect achieved by the heat exchanger assemblies 26,28. It may be desirable to reduce the exposure of the second heat exchanger assembly 28 in order to warm a contained fluid. For example, it may be desirable to warm a portion of transmission oil, in order to increase efficiency of the system, e.g. after start-up of a vehicle.

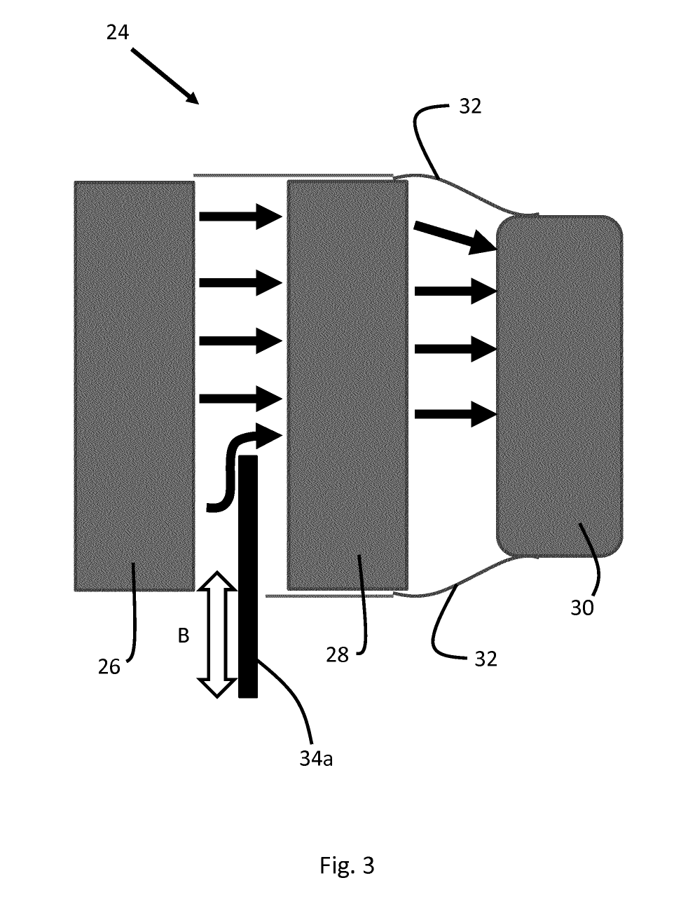

In FIG. 3, the heat exchanger system 24 comprises an adjustable baffle 34a. The baffle 34a is arranged between the first and second heat exchanger assemblies 26,28, and is operable to be advanced or retracted into the space between the heat exchanger assemblies 26,28, as indicated by arrow B. The baffle 34a presents an adjustable barrier in the flow path of the heat exchanger system 24, such that the flow path between the first heat exchanger assembly 26 and the second heat exchanger assembly 28 is limited by the position of the baffle 34a and the walls of the fan shroud 32.

The baffle 34a may comprise a plate member coupled with a linear actuator arranged to move the baffle 34a in a linear motion. Additionally or alternatively, the baffle 34a may comprise a telescopic plate member, a roller shutter system, an aperture twist shutter, or any apparatus suitable to provide for an adjustable barrier height or dimensions. It will be understood that the fan shroud 32 may comprise an aperture 36 arranged to receive the baffle 34a, to allow for the relative motion of the baffle 34a into and out of the flow path of the heat exchanger system 24. Alternatively, the baffle 34a may be fully retained within the interior of the heat exchanger system 34a, even when fully retracted, e.g. through use of a roller shutter system.

By adjustment of the height of the baffle 34a in the flow path, while air may be drawn through the entire area of the first heat exchanger assembly 26, airflow may be restricted to pass through only a portion of the area of the second heat exchanger assembly 28, based on how much the adjustable baffle 34a is extended to block or cover the second heat exchanger assembly 28.

By blocking a portion of the exchanger, the pressure drop across the fan is increased, which can lead to a corresponding increase in fan consumption. In one aspect, in order to decrease the quantity of energy exchanged, fan speed can be reduced, thereby reducing fan energy consumption. Alternatively, if the fan speed must be high for some portion of the assembly, the baffle is arranged to reduce the airflow in other areas of the system.

As the cooling effects of the different exchangers of the system can be adjusted independently, the overall vehicle efficiency can be improved, due to a faster response time for separate vehicle systems to reach their optimal temperatures.

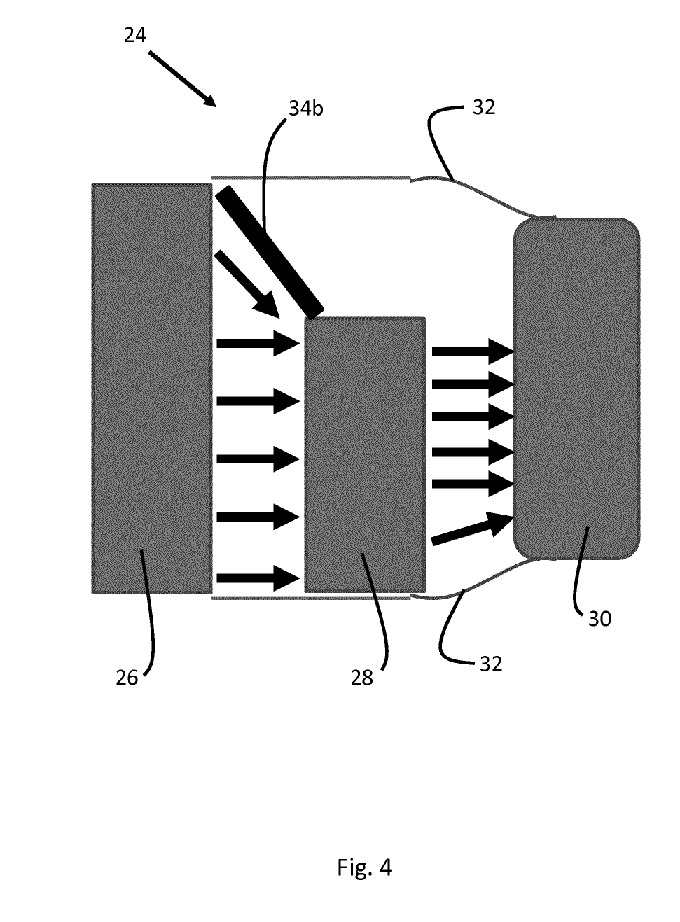

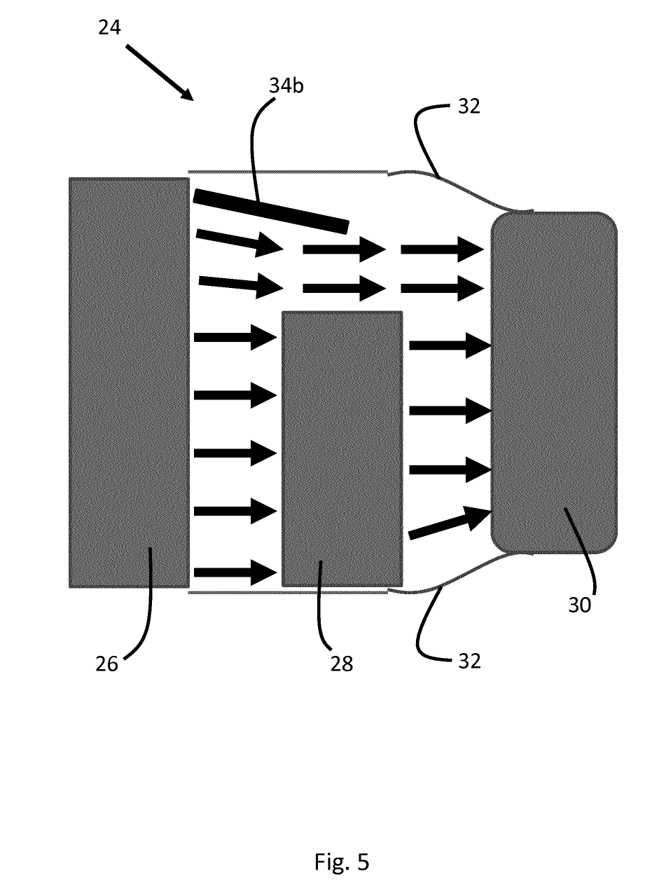

A further embodiment of the invention is illustrated in FIGS. 4 and 5. In this embodiment, the second heat exchanger assembly 28 is of reduced height relative to the first heat exchanger assembly 26. A bypass baffle 34b is arranged in the heat exchanger system 24, to direct airflow along a flow path between the heat exchanger assemblies 26,28. The bypass baffle 34b is hingedly mounted in the heat exchanger system 24, arranged to pivot between a closed position, shown in FIG. 4, and an open position, shown in FIG. 5.

In the closed position shown in FIG. 4, the bypass baffle 34b is arranged such that substantially the entire airflow through the first heat exchanger assembly 26 is directed by the baffle to flow through the second heat exchanger assembly 28.

In the case that the subsystem to which the second heat exchanger assembly 28 is connected has a reduced need for airflow through the assembly 28, e.g. due to a reduction in the cooling requirements for the subsystem, the bypass baffle 34b may be controlled to hinge to the open position, as shown in FIG. 5. In this situation, a portion of the airflow through the first heat exchanger assembly 26 is allowed to bypass the second heat exchanger assembly 28 completely, thereby reducing the cooling level of the second heat exchanger assembly 28.

It will be understood that the angular position of the bypass baffle 34b may be controlled to adjust the level of airflow that bypasses the second heat exchanger assembly 28, thereby controlling the cooling level of the second heat exchanger assembly 28 for a given fan flow level. Furthermore, while the bypass baffle 34b is shown as a hinged baffle, it will be understood that other baffle constructions may be used, e.g. a roller shutter baffle, a telescoping baffle member, etc.

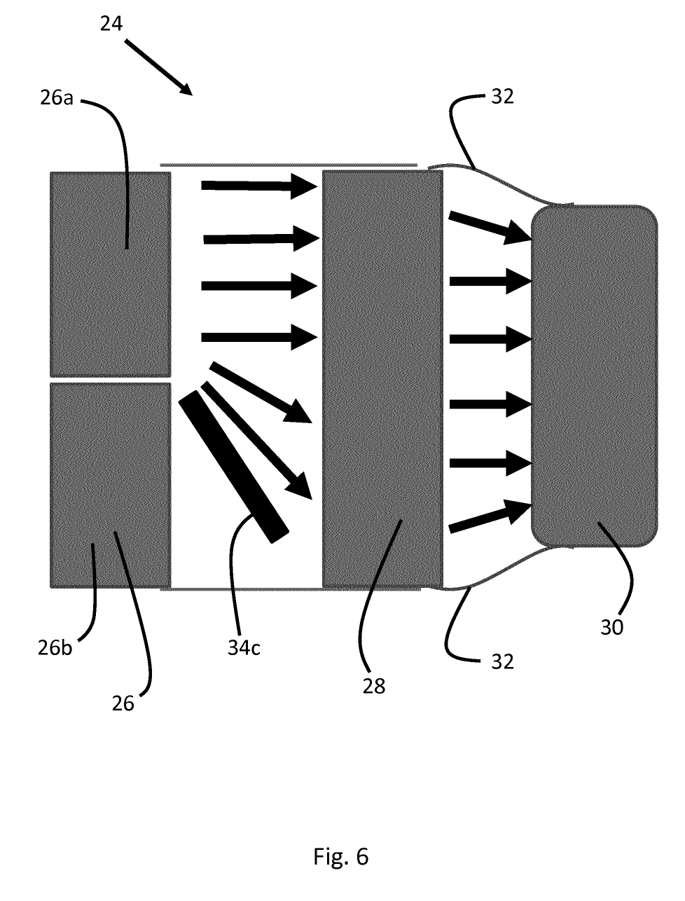

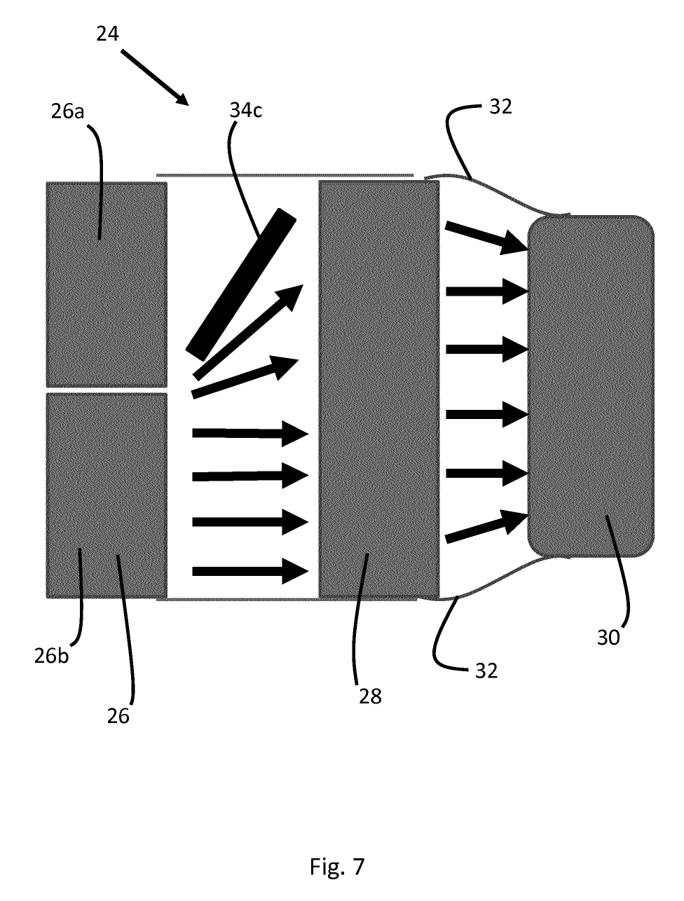

In a further embodiment of the invention, the use of an adjustable baffle can allow for the variation of airflow through heat exchangers which are provided as part of a heat exchanger assembly. In FIGS. 6 and 7, the first heat exchanger assembly 26 comprises an upper heat exchanger 26a and a lower heat exchanger 26b. An adjustable baffle 34c is provided downstream of the first heat exchanger assembly 26, and arranged to control the flow path for airflow drawn through the heat exchanger system 24 by the fan 30. The baffle 34c is illustrated as a hinged baffle member, hingedly mounted at the downstream side of the first heat exchanger assembly 26, and operable to hinge between a lower position, as shown in FIG. 6, and an upper position, as shown in FIG. 7.

In FIG. 6, the upper heat exchanger 26a has a greater cooling requirement than the lower heat exchanger 26b. Accordingly, the baffle 34c is hinged to the lower position, to define a flow path for the heat exchanger system 24 wherein airflow is primarily drawn through the upper heat exchanger 26a, while the flow path through the lower heat exchanger 26b is largely blocked or restricted by the baffle 34c in the lower position.

Similarly, when the lower heat exchanger 26b has a greater cooling requirement than the upper heat exchanger 26b, the baffle 34c is hinged to the upper position as shown in FIG. 7. As a result, airflow is primarily drawn through the lower heat exchanger 26b, while the flow path through the upper heat exchanger 26a is largely blocked or restricted by the baffle 34c in the upper position.

As a result of the adjustment of the position of the baffle 34c, the proportion of airflow through the upper and lower heat exchangers 26a,26b can be varied, resulting in improved performance control for the overall heat exchanger system 24. It will be understood that the angular position of the baffle 34c may be controlled to adjust the proportional level of airflow that flows through the heat exchangers 26a,26b. In addition, it will be understood that the baffle 34c may be positioned at a neutral position, e.g. aligned in a horizontal direction, or retracted such that equal airflow is provided through the upper and lower heat exchangers 26a,26b. Furthermore, while the bypass baffle 34b is shown as a hinged baffle, it will be understood that other baffle constructions may be used, e.g. a roller shutter baffle, a telescoping baffle member, etc.

The operation of the adjustable baffles 34a,34b,34c may be controlled from a central computer provided in the tractor, and/or an engine control unit (ECU) arranged to adjust engine performance based on sensor inputs. In a further aspect, the heat exchanger systems may be provided with an auxiliary adjustable baffle (not shown) which may be arranged upstream of the first heat exchanger assembly 26, to control or redirect airflow drawn into the first heat exchanger assembly 26. The auxiliary adjustable baffle may comprise any suitable baffle construction, such as those described in the above embodiments.

Examples of use cases for the adjustable baffle system can include:
When defrosting windows, e.g. upon starting a vehicle in the morning, high air flow is required on the HVAC condenser to improve HVAC performance. Accordingly, other coolers may be bypassed, and/or additional airflow may be redirected to such a condenser.
When a heat exchanger assembly is part of an occasionally high consumption subsystem, and requires additional cooling based on the operational tasks being performed, e.g. tractor hydraulics. Accordingly, other coolers may be bypassed, and/or additional airflow may be redirected to the associated hydraulic oil cooler.

It will be understood that the features of the different embodiments may be combined with each other, to provide for increased levels of system operation and control. The use of an adjustable baffle 34a,34b,34c allows for greater control over the heat exchanger airflow, and how the airflow is allocated to different heat exchangers in the system.

The invention is not limited to the embodiments described herein, and may be modified or adapted without departing from the scope of the present invention.

1. A heat exchanger system for a vehicle, the system comprising:
a first heat exchanger assembly;
a second heat exchanger assembly located downstream of said first heat exchanger assembly; and
at least one baffle arranged between the first heat exchanger assembly and the second heat exchanger assembly, wherein said at least one baffle is adjustable to provide for variation of airflow between said first heat exchanger assembly and said second heat exchanger assembly, wherein at least one of said first and second heat exchanger assemblies comprises a plurality of separate heat exchanger subsections, wherein said at least one baffle is adjustable to control airflow to or from said separate heat exchanger subsections, said at least one baffle is actuable between a first position and a second position, and when in said first position, said at least one baffle is arranged to direct an output airflow from said first heat exchanger assembly as an input airflow to said second heat exchanger assembly; and when in said second position, said at least one baffle is arranged to direct at least a portion of the output airflow from said first heat exchanger assembly to bypass said second heat exchanger assembly.

2. The heat exchanger system of claim 1, wherein said at least one baffle is provided as at least one of the following: a hinged member; a linearly actuable member; a telescopic member.

3. The heat exchanger system of claim 1, wherein said first and second heat exchanger assemblies comprise at least one of a liquid coolant radiator and an air radiator.

4. (canceled)

5. The heat exchanger system of claim 1, wherein at least one of said first and second heat exchanger assemblies comprises a plurality of heat exchangers, wherein said at least one baffle is adjustable to vary the proportion of airflow through the respective heat exchangers of said plurality.

6. The heat exchanger system of claim 1, wherein the heat exchanger system comprises an additional baffle arranged upstream of said first heat exchanger assembly, wherein said additional baffle is adjustable to provide for variation of airflow into said first heat exchanger assembly.

7. The heat exchanger system of claim 1, wherein the heat exchanger system comprises at least one fan arranged in series with said first and second heat exchanger assemblies, said at least one fan arranged to cause air to be drawn through or blown into the heat exchanger assemblies of the heat exchanger system.

8. The heat exchanger system of claim 1, wherein said at least one baffle is arranged to selectively cover at least a portion of said second heat exchanger assembly, to prevent airflow through the portion of the second heat exchanger assembly.

9. An agricultural vehicle comprising a heat exchanger system as claimed in claim 1.

10. An agricultural vehicle as claimed in claim 9, comprising:
an engine;
an engine control unit (ECU) arranged to adjust engine performance based on sensor inputs; and
the heat exchanger system coupled to said engine, wherein said ECU is operable to adjust the at least one baffle of said heat exchanger system based on sensor inputs received by said ECU.
